(19) United States
(12) Patent Application Publication
(10) Pub. No.: US 2004/0024940 A1
(43) Pub. Date: Feb. 5, 2004

(54) Central processing unit card with accelerated graphic port

(76) Inventor: Tsai-Sheng Chiu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,237

(22) Filed: Sep. 27, 2002

(30) Foreign Application Priority Data
Jul. 30, 2002 (TW) 091211679

(51) Int. Cl. G06F 13/00

(52) U.S. Cl. 710/301; 710/315

(57) ABSTRACT

A central processing unit (CPU) card with an accelerated graphic port (AGP) is disclosed herein. The CPU card is formed with PCI contact pads and AGP contact pads, or/and EISA contact pads. The PCI contact pads, and/or EISA contact pads and AGP contact pads are respectively inserted into a PCI expansion slot and an EISA expansion slot or an AGP expansion slot. As the result, transmission of image and data signals are implemented between the CPU card and a computer backplane by way of insertion of the AGP and/or EISA contact pads, in the AGP bus. Therefore, the present invention is capable of improving conventional technology in need of usage of flat cables to electrically interconnect between a required external AGP card and the CPU card, and in a lower running speed.

### BACKGROUND OF INVENTION

1. Field of the Invention

The present invention relates to a central processing unit card, and more particularly in a central processing unit (CPU) card with an accelerated graphic port (AGP).

2. Description of the Prior Art

In complying with the explosive progress in an information technology, personal computers and notebooks have been widely applied to various kinds of industries to promote manufacturing efficiency. In manufacturing industries, in particular, people use industrial computers to help them to produce different kinds of products. Therefore, peripheral devices for industrial computers, such as motherboards, image-displaying cards, and hard disk drives, are respectively designed with fast-calculating ability, prompt image-displaying ability, and high density storing space.

In industrial computers, specifically, a computer server must be capable of communicating with other computers or being controlled by a remote terminal. Whatever it is in communication or remote control, the computer server almost needs an image-displaying interface, such as a display card, to transmit each of operating images generated from a display device, among the computer server, other computers or terminals. As known, the operating images must be expressed in relation to each step of production processes. The performance of the operating image generated by the display card depends on the bus standards of the display card. An accelerated graphic port (AGP) is, for example, one of the most popular bus standards with regard to display card.

Please refer to FIG. 1, which is a schematic diagram of a CPU interface card 100 having an AGP bus according to the prior art. The CPU interface card 100 electrically connects to an AGP display card 104 with golden fingers 102 thereon for image transmissions. Meanwhile, one of the conventional disposition methods is, as shown in FIG. 1, to insert the AGP display card 104 into an expansion slot 106 installed on the CPU interface card 100. Another one is to use an AGP flat cable 108 to interconnect between the AGP expansion slot 106 of the CPU interface card 100 and the display card 104. However, there are some flaws for the above two disposition methods. For the former one, the AGP display card 104 must be approximately perpendicular to the CPU interface card 100 after being inserted into the AGP slot 106, resulting in a less space for the reception of other adjacent interface cards. For the latter one, the length of the AGP flat cable 108 effects on the transmission speed of AGP signals. Additionally, usage of AGP flat cables 108 to interconnect between the AGP display card 104 and the AGP slot 106 easily results in a more poor, an unstable connection or inconvenience in installation. If an AGP display interface has been built into the CPU interface card 100, any other model display cards presently required by the user will be not capable of being used to replace the previous one on the same CPU interface card 100, resulting in uselessness of the CPU interface card 100.

Therefore, how to properly allocate an AGP display card onto a CPU interface card and how to increase compatibility of a CPU interface card have become an important issue for CPU interface card manufacturers.

### SUMMARY OF INVENTION

It is therefore a primary objective of the claimed invention to provide a CPU interface card formed with an accelerated graphic port as being AGP contact pads.

A second objective of the claimed invention provides the insertion of the CPU interface card into an expansion slot disposed on the computer backplane to transfer AGP signals between an external AGP card of the computer backplane and the CPU interface card, by way of the AGP contact pads of the CPU interface card.

A third objective of the claimed invention provides the CPU interface card having AGP contact pads in compliance with the specification of one of industrial bus standards to constitute a AGP bus for image data transmission.

A fourth objective of the claimed invention provides the electrical connection of CPU interface card to a variety of display cards installed on the computer backplane by way of AGP contact pads, for expandability of the display card.

According to the claimed invention, the CPU interface card has an AGP for adapting to a computer backplane to form a computer system. The CPU interface card forms thereon a plurality of industry standard architecture (EISA) contact pads corresponding to an EISA bus for electrically connecting to the computer backplane. The EISA contact pads transfer data via EISA bus between the computer backplane and the CPU interface card. The CPU interface card further forms a plurality of AGP contact pads interlaced with the EISA contact pads to constitute an AGP bus in compliance with the standard configuration of the EISA contact pads for electrically connecting to the computer backplane. It means that the AGP contact pads are capable to transmit image data between the computer backplane and the CPU interface card, via an AGP bus in utilization of the standard configuration of EISA contact pads for adapting to electrically contact with an EISA expansion slot disposed on the computer backplane.

The EISA contact pads are formed on the CPU interface card apart from the PCI contact pads in a predetermined distance. After being electrically connected to computer backplane, the CPU interface card can transfer image data to the computer backplane via the EISA contact pads in EISA bus. The EISA contact pads of the CPU interface card are inserted into an EISA expansion slot of the computer backplane for forming a stable electrical connection between the CPU interface card and the computer backplane. In the third embodiment of the present invention, the PCI contact pads and the EISA contact pads are disposed in alignment on the CPU interface card thereby inserting into the PCI expansion slot 406a and the EISA expansion slot 404a, simultaneously.

The AGP contact pads are disposed on the CPU interface card and interlaced with the EISA contact pads. The AGP contact pads utilize the standard specification of the EISA contact pads to constitute an AGP bus thereby performing the image-data transmission between the CPU interface card and the computer backplane. It means that the AGP contact pads are used to be directly inserted into and then electrically contact with an EISA expansion of the computer backplane for image-data transmission, in compliance with the standard configuration of the EISA contact pads. In the first and third embodiments of the present invention, the AGP contact pads are interlaced with the EISA contact pads thereby utilizing the standard configuration of the EISA contact pads to define a path of AGP signal transmission.

In the third embodiment of the present invention, a plurality of AGP contact pads are formed on the CPU interface card with a plurality of EISA contact pads and PCI contact pads which respectively connect with corresponding circuits formed on the backplane. By said specific circuits, the AGP contact pads of the CPU interface card are capable of utilizing the standard configuration of the EISA contact pads to constitute an AGP bus for image-data transmission between the CPU interface card and an external AGP card installed on the backplane. Such design replaces AGP flat cables of the prior art, and then gets more advantages in installation of different types external AGP cards in the system.

In other words, the present invention provides a CPU interface card having an AGP. The AGP contact pads of the CPU interface card can be correspondingly connected to the AGP expansion slot or the EISA expansion slot of the computer backplane. The AGP contact pads of the CPU interface card can also electrically comply with one of a variety of standard buses. The CPU interface card can selectively connect to an external AGP interface card to improve the expandability of a display card and the efficiency of image data transmission. In such a way, the efficiency of the CPU interface card of an industrial computer gains significantly.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a CPU interface card according to the prior art;

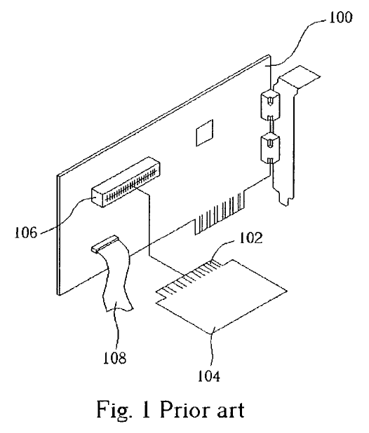

FIG. 2 is a schematic diagram of a first preferred embodiment of a CPU interface card having an AGP according to the present invention;

FIG. 3 is a schematic diagram of a second preferred embodiment of a CPU interface card having an AGP according to the present invention; and

FIG. 4 is a schematic diagram of a third preferred embodiment of a CPU interface card having an AGP according to the present invention.

### DETAILED DESCRIPTION

The present invention overcomes drawbacks of a prior art CPU interface card of an industrial computer. The present invention discloses a CPU interface card formed with a plurality of AGP contact pads which are able to be inserted into an expansion slot of the computer backplane in compliance with other different industrial bus standard. It permits that the CPU interface card can be selectably electrically connected with different external AGP cards used in the backplane and thus is capable of increasing expandability and data transmission efficiency of the AGP display card. The present invention the CPU interface card having an AGP will be described in the following paragraphs and corresponding drawings.

The above-mentioned industrial bus standards include extended industry standard architecture (EISA), peripheral component interconnect (PCI), and other similar buses. The EISA and the PCI bus standard will be illustrated as two examples in the following description.

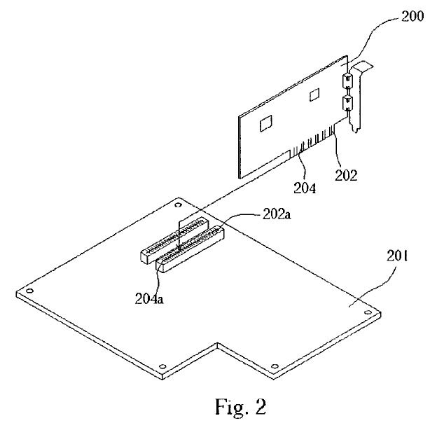

Please refer to FIG. 2, which is a schematic diagram of a first preferred of a CPU interface card 200 having an AGP according to the present invention. The CPU interface card 200 cooperates with a computer backplane 201 to build up a computer system. The computer backplane 201 comprises an EISA expansion slot 204a. The CPU interface card 200 forms a plurality of EISA contact pads 204 and AGP contact pads 202 on one edge thereof. The contact pads 202 and 204 may be designed as golden fingers or electrical contacts of a typical interface card.

The EISA contact pads 204 are formed on the CPU interface card 200 for constituting an EISA bus. After being electrically connected to the computer backplane 201, the CPU interface card 200 can transfer data to the computer backplane 201 by way of the EISA contact pads 204 in EISA bus. Specifically, the EISA contact pads 204 of the CPU interface card 200 are inserted into the EISA expansion slot 204a of the computer backplane 201 for information transmission.

The CPU interface card 200 further forms a plurality of AGP contact pads 202 on the edge thereof for constituting an AGP bus. The AGP contact pads 202 are designed as interlaced with the EISA contact pads 204 or electrically connected with parts of the EISA pads 204. After being electrically connected to the computer backplane, the CPU interface card 200 can transfer image data to the computer backplane 201 via the AGP contact pads 202 or the part of EISA contact pads 204 in electrical contact with the AGP contact pads 202. The AGP contact pads 202 of the CPU interface card 200 are also inserted into the EISA expansion slot 204a, which are electrically connected to a corresponding circuit formed on the computer backplane 201 for image-data transmission in AGP bus.

In the first preferred embodiment, the AGP contact pads 202 and the EISA contact pads 204 are both formed on the CPU interface card 200 and interlaced with each other, so that no additional space on the CPU interface card 200 is required for allocation of AGP contact pads. Substantially, the AGP contact pads 202 directly utilize the standard configuration of the EISA contact pads 204 to be a data-transmitting pathway of AGP bus. The AGP interface of the CPU interface card 200 of the present invention may adopt an AGP standard specification with 1×, 2×, 4×, or a higher clock multiplier factor.

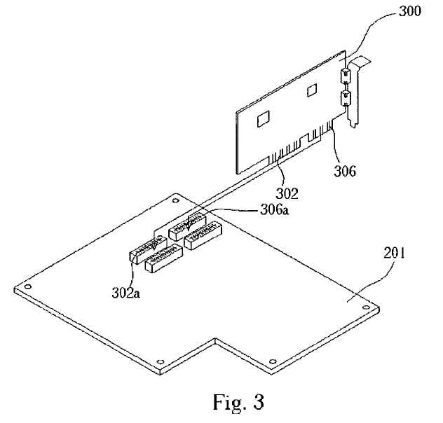

Please refer to FIG. 3, which shows a second preferred embodiment of a CPU interface card 300 having an AGP according to the present invention. The CPU interface card 300 comprises a plurality of AGP contact pads 302 and PCI contact pads 306 formed on one edge of the CPU interface card 300. The PCI contact pads 306 of the CPU interface card 300 constitute a PCI bus after being electrically connected to a PCI expansion slot 306a of the computer backplane 201. The CPU interface card 300 would be able to transfer data to the computer backplane 201 via the PCI bus.

The AGP contact pads 302 formed on the CPU interface card 300 are neighbored apart from the PCI contact pads 306 in a predetermined distance, and constitute an AGP bus after being electrically connected to an AGP expansion slot 302a disposed on the computer backplane 201. The CPU interface card 300 therefore can transfer image data to the computer backplane 201 via the AGP bus. The AGP bus serves as a video data transmission path of the CPU interface card 300 and correspondingly connects to the AGP contact pads 302.

In the second preferred embodiment of the present invention, the AGP contact pads 302 are designed corresponding to an external AGP display card used on the backplane, and dedicated as an specific bus between a graphic chip and a CPU of the CPU interface card 300. The AGP contact pads 302 are capable of rapidly transmitting lots of image data between memory of the CPU interface card 300 and a graphic chip.

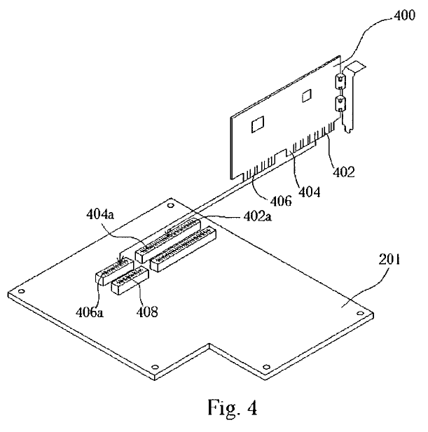

Please refer to FIG. 4, which is a third preferred embodiment of a CPU interface card 400 having an AGP according to the present invention. The CPU interface card 400 comprises a plurality of AGP contact pads 402, EISA contact pads 404, and PCI contact pads 406 formed on one edge of the CPU interface card 400. The PCI contact pads 406 formed on the CPU interface card 400 can constitute a PCI bus after being electrically connected to a PCI expansion slot 406a disposed on the computer backplane 201. The CPU interface card 400 therefore can transfer data to the computer backplane 201 via the PCI bus.

The EISA contact pads 404 formed on the CPU interface card 400 are neighbored apart from the PCI contact pads 406 in a predetermined distance. The EISA contact pads can constitute an EISA bus after being electrically connected to an EISA expansion slot 404a disposed on the computer backplane 201. The CPU interface card 400 therefore can transfer data to the computer backplane 201 via the EISA bus. Since the PCI contact pads 406 and the EISA contact pads 404 are disposed in alignment, and thus they can be stably inserted into both the PCI expansion slot 406a and the EISA expansion slot 404a of the backplane 201, simultaneously.

In the third preferred embodiment, the AGP contact pads 402 formed on the CPU interface card 400 are interlaced with the EISA contact pads 404 or electrically connected with parts of EISA contact pads 404 to constitute a AGP bus in usage of standard configuration of the EISA contact pads after the AGP contact pads 402 of the CPU interface card 400 is also inserted into the EISA expansion slot 404a. Meanwhile, the AGP contact pads 402 are electrically connected to a corresponding circuit on the CPU interface card 400. Such an AGP bus serves as image-data transmissions between the CPU interface card 400 and the computer backplane 201. In the third preferred embodiment of the present invention, the AGP contact pads 402 interlaced with the EISA contact pads 404 utilize a standard specification of EISA contact pads to electrically contact with the AGP expansion slot 404a of the computer backplane 201 thereby constituting said AGP bus. Then, the AGP bus is electrically linked to another AGP expansion slot 408 of the computer backplane 201, which receives an external AGP card as required. Thus, the CPU interface card 400 can electrically connect to a variety of required AGP interface cards installed on the computer backplane 201.

As aforementioned, the AGP contact pads 402 are correspondingly disposed on the same CPU interface card 400 with the EISA contact pads 404 and the PCI contact pads 406. The AGP contact pads 402 of the CPU interface card 400 in compliance with the standard specification of the EISA contact pads is capable to transfer AGP signals the required external AGP card installed on the computer backplane, by way of using an AGP bus. The present invention performs a better solution for selectively electrically connecting different types AGP cards to the CPU interface card than the prior art did.

In summary, the present invention provides a CPU interface card having an AGP. The AGP contact pads of the CPU interface card can be correspondingly connected to the AGP expansion slot or the EISA expansion slot of the computer backplane. The AGP contact pads of the CPU interface card for electrically connecting to the EISA expansion slot are designed in compliance with the specification of one of a variety of standard buses, i.e. EISA. The CPU interface card can selectively connect to a required external AGP interface card to improve the expandability of a display card and the efficiency of image data transmission. In such a way, the efficiency of the CPU interface card of an industrial computer gains significantly.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A central processing unit (CPU) interface card having an accelerated graphic port (AGP) for adapting to a computer backplane to form a computer system, the CPU interface card comprising:
a plurality of extended industry standard architecture (EISA) contact pads corresponding to an EISA bus for electrically connecting to the computer backplane, the EISA contact pads transferring data between the computer backplane and CPU card according to the EISA bus; and
a plurality of AGP contact pads interlaced with the EISA contact pads in compliance with the standard configuration of the EISA contact pads to constitute an AGP bus thereby transferring image data between the CPU interface card and the computer backplane.

2. The CPU interface card as described in claim 1 wherein the AGP contact pads of the CPU interface card are inserted into and then electrically connected with an EISA expansion slot of the computer backplane for image data transmission.

3. The CPU interface card as described in claim 2 wherein the EISA contact pads of the CPU interface card are inserted into and then electrically connected with the EISA expansion slot of the computer backplane for data transmission.

4. The CPU interface card as described in claim 1 wherein the AGP contact pads of the CPU interface card are interlaced with the EISA contact pads to increase disposition variation of the AGP contact pads and the EISA contact pads on the CPU interface for space saving.

5. A CPU interface card having an AGP for adapting to a computer backplane to form a computer system, the CPU interface card comprising at least:
a plurality of peripheral component interconnect (PCI) contact pads corresponding to a PCI bus which serves data transmissions between the computer backplane and the CPU interface card when the PCI contact pads are electrically connected to the computer backplane; and
a plurality of AGP contact pads disposed apart from the PCI contact pads in a predetermined distance to constitute an AGP bus thereby transferring image data between the computer backplane and the CPU interface card when the AGP contact pad are electrically connected to the computer backplane.

6. The CPU interface card as described in claim 5 wherein the AGP contact pads of the CPU interface card are inserted into and then electrically connected to an AGP expansion slot of the computer backplane for image data transmission.

7. The CPU interface card as described in claim 6 wherein the PCI contact pads of the CPU interface card are inserted into and then electrically connected to a PCI expansion slot of the computer backplane for data transmission wherein the PCI expansion slot is disposed in alignment with the AGP expansion slot.

8. A CPU interface card having an AGP for adapting to a computer backplane to form a computer system, the CPU interface card comprising:
a plurality of PCI contact pads corresponding to a PCI bus which serves data transmission between the computer backplane and the CPU interface card when the PCI contact pads electrically connected to the computer backplane;
a plurality of EISA contact pads disposed apart from the PCI contact pads in a predetermined distance to constitute a EISA bus which serves data transmission between the computer backplane and the CPU interface card when the EISA contact pads are electrically connected to the computer backplane; and
a plurality of AGP contact pads interlaced with the EISA contact pads, in compliance with the standard configuration of the EISA contact pads to constitute an AGP bus which serves data transmission between the computer backplane and the CPU interface card when the AGP contact pads are electrically connected to the computer backplane.

9. The CPU interface card as described in claim 8 wherein the AGP contact pads of the CPU interface card are inserted into and then electrically connected to an EISA expansion slot disposed on the computer backplane for image data transmission.

10. The CPU interface card of claim 9 wherein the EISA contact pads of the CPU interface card are inserted into and then electrically connected to the EISA expansion slot of the computer backplane for data transmission.

11. The CPU interface card of claim 10 wherein the AGP contact pads are interlaced with the EISA contact pads to increase disposition variation of the AGP contact pads and the EISA contact pads for space saving.

12. The CPU interface card of claim 8 wherein the PCI contact pads of the CPU interface card are inserted into and then electrically connected to a PCI expansion slot for data transmission.

13. The CPU interface card of claim 8 wherein the PCI contact pads and the EISA contact pads are disposed in alignment on the CPU interface card for proper respective insertion into the PCI expansion slot and the EISA expansion slot.
